(19) United States
(12) Patent Application Publication
(10) Pub. No.: US 2020/0095143 A1
(43) Pub. Date: Mar. 26, 2020

(54) INJECTION SYSTEM FOR WASTEWATER TREATMENT

(71) Applicant: IER Environmental Services, Inc., Loon Lake, WA (US)

(72) Inventors: Joseph Hennessy, Maple Valley, WA (US); Richard Handley, Loon Lake, WA (US); Douglas G. Kelley, Wenatchee, WA (US)

(21) Appl. No.: 16/579,230

(22) Filed: Sep. 23, 2019

Related U.S. Application Data
(60) Provisional application No. 62/734,930, filed on Sep. 21, 2018.

(51) Int. Cl. C02F 1/72; C02F 1/68; C02F 1/00

(52) U.S. Cl. CPC C02F 1/727; C02F 1/685; C02F 2209/38; C02F 2209/22; C02F 1/008

(57) ABSTRACT

A system and method for monitoring and altering the conditions of a sewage system comprising a wet well connected to a sewer. The wet well is also configured to provide sewage to a secondary system, where the sewage is fed into an oxygen contact chamber. That chamber is fed oxygen which is dissolved into the sewage such that the sewage in the contact chamber has elevated oxygen content. That oxygenated sewage is then fed into the sewage system in order to raise oxygen levels and control anaerobic activity. Sensors and valves of the system are controlled by a central controller which provides for improved functionality, energy savings, and automated function.

### PRIORITY CLAIM

This application claims priority to U.S. Provisional Patent Application Ser. No. 62/734,930, filed Sep. 21, 2018, the entirety of which is hereby incorporated by reference as if fully stated herein.

### FIELD OF THE INVENTION

This invention relates generally to wastewater treatment, and, more specifically, to odor control through control of conditions within wastewater.

### BACKGROUND OF THE INVENTION

Modern wastewater treatment is a foundational element of nearly every community. Wastewater carries with it, however, various side effects, the most contentious of which is malodor. Many wastewater conveyance systems, those are the systems that transfer wastewater to the treatment facility, attempt to control odor through application of chemicals prior to the waste reaching the wastewater treatment facility. Chemical additions attempt to prevent the formation of anaerobic conditions, which lead to malodourous H₂S gas, by providing a source of oxygen. An additional problem with the formation of H₂S is that it is acidic, and corrodes sewer pipes.

A common chemical used for this is the application of BIOXIDE®, which is a calcium nitrate solution. This traditional approach requires the continuous application of the chemical. Continuous chemical application results in excessive and constant cost to sewer management districts. Further, the chemical addition produces nitrogen gas, which carries suspended solids to the surface of the wastewater forming a cake, requiring additional pump off and money to complete. Other common chemicals include hydrogen peroxide, bleach, caustic soda, and ferric chloride. These all require the same type of costly continuous application.

Other prior art systems have attempted O₂ control in a similar manner to chemical control, i.e. adding large amounts without much care or precision. In addition to providing a solution which controls the formation of malodorous H₂S without the disadvantages in prior art techniques, the present invention also improves on these prior art systems by providing a more precise approach that enables increased energy and other financial savings through carefully controlling the conditions in the system.

### SUMMARY OF THE INVENTION

In a traditional sewer system, a wet well is used to collect sewage. A force main then draws sewage from the wet well and propels it toward the sewage treatment center. The force main is generally under pressure, as it moves the sewage against gravity until it reaches a point at which the sewage may flow more naturally.

The present invention comprises a controlled and monitored system for adding oxygen (O₂) to the sewage located in the force main and or wet well. The addition of O₂ prevents anaerobic conditions from forming and as a result controls the production of malodorous and corrosive H₂S gas. Additionally, because the force main is under pressure, a greater concentration of dissolved O₂ can be achieved.

In accordance with other examples of the invention, the present system provides for a method of controlling odor and corrosion in a wastewater conveyance system in which a sensor is placed in a location within the wastewater conveyance system where oxygen is being injected into the wastewater conveyance system, and where the sensor sends a signal to an electrical control panel, which responds by opening or closing a valve or turning on/off a pump, or ramping up/down a variable frequency drive (“VFD”) in order to maintain a certain reading on the sensor in the location where oxygen is being injected into the wastewater conveyance system.

In accordance with still further examples of the invention, the sensor can be selected from the group consisting of dissolved oxygen probe, gas-phase oxygen probe, soluble sulfide probe, or gas-phase sulfide probe, ORP Probe (oxidation reduction potential). In various embodiments, the sensor may be composed of a sending unit, and a receiver. The sending unit may be placed at the source of the preferably sensed condition, and the receiver may be located elsewhere, in communication with the controller, or may be mounted at or in the controller itself.

In accordance with yet other examples of the invention, a method to control odor and corrosion in a wastewater conveyance system in which a sensor is placed in a wastewater conveyance system that is downstream of the where oxygen is being injected into the wastewater conveyance system, wherein the sensor sends a signal to an electrical control panel, which responds by opening or closing a valve (or turning on/off a pump, or ramping up/down a VFD) in order to maintain a certain reading on the sensor in the downstream section of the wastewater conveyance system.

In accordance with still another example of the invention, the sensor can be selected from the group consisting of dissolved oxygen probe, gas-phase oxygen probe, soluble sulfide probe, or gas-phase sulfide probe, ORP Probe (oxidation reduction potential).

In accordance with still further examples of the invention, the present invention provides for a method to control odor and corrosion in a wastewater conveyance system in which two or more sensors are placed within a wastewater conveyance system, wherein at least one sensor is located where oxygen is being injected into the wastewater conveyance system, and at least one other sensor is located downstream of where the oxygen is being injected into the wastewater conveyance system, wherein the two or more sensors send signals to an electrical control panel, which responds by opening/closing valves (or turning on/off a pumps, or ramping up or down a VFDs) to two or more different oxygen injection points in order to maintain a certain reading on each sensor at both sensing locations in the wastewater conveyance system.

In accordance with yet another example of the invention, the two or more sensors can be selected from the group consisting of dissolved oxygen probe, gas-phase oxygen probe, soluble sulfide probe, or gas-phase sulfide probe, ORP Probe (oxidation reduction potential).

In accordance with further examples of the invention, the oxygen is injected either directly into the primary wastewater conveyance system line, or into a side-stream of wastewater that is extracted from the primary wastewater conveyance system line and reinjected into the wastewater conveyance system at one or more injection points.

In accordance with still further examples of the invention, the method of injecting oxygen into the wastewater conveyance system involves the use of one of the following: contact chamber (Mass Transfer Saturator, Speece Cone), venturi (eductor), and/or direct injection of oxygen gas.

In accordance with additional examples of the invention, the sensor information collected at the electrical control panel, from various possible sensors (dissolved oxygen, oxygen gas, dissolved sulfide, hydrogen sulfide, ORP, pH, etc.) at various possible locations within the wastewater conveyance system, is sent to one or more computers (local and/or remote), so that changes can be made to the dosing of oxygen into one or more possible feed locations.

In accordance with yet other examples of the invention, the wastewater conveyance system refers to a municipal sewer line, collection system, STEP system, force main, gravity line, or land application (irrigation) system.

In accordance with other examples of the invention, the feed location where oxygen is being injected is selected from the group consisting of wet well, pump station, lift station, manhole, full pipe, siphon break section of pipe, headworks, force main, gravity line, lake, lagoon, basin, vault, sump, etc.

In accordance with still other examples of the invention, the oxygen being injected into the wastewater conveyance system also contains ozone.

In accordance with still further examples of the invention, the system is capable of automatic control, via the controller system, such that preferred oxygen conditions can be maintained in the wastewater conveyance system. Further, the same level of control can extend to various other components, such as the compressor, and provide for additional cost savings via electricity pricing optimization.

These and other examples of the invention will be described in further detail below.

### BRIEF DESCRIPTION OF THE DRAWINGS

Preferred and alternative examples of the present invention are described in detail below with reference to the following drawing:

FIG. 1 is a schematic of an Injection System according to an embodiment of the present invention.

### DETAILED DESCRIPTION OF THE PREFERRED EMBODIMENT

In accordance with an example of the present invention, sewage is located in a wet well as part of a wastewater conveyance system. The wastewater conveyance system refers to a municipal sewer line, collection system, STEP system, force main, gravity line, or land application (irrigation) system. One or more pumps are generally also located in the wet well or in a dry pit adjacent to the wet well. These pumps allow sewage to be pumped into a pipe, known as a force main, from the wet well. The force main is generally under pressure, moving the sewage against gravity toward a point in the line after which it can flow freely toward the treatment facility. As the sewage sits in the force main, and in the wet well, the available oxygen is depleted. Once the oxygen levels are low enough, anaerobic conditions occur within the force main. Bacteria operating in these anaerobic conditions produce H₂S gas. This gas is corrosive, destroying the sewer lines, and malodorous.

The objective of the present invention is to add the correct amount of dissolved oxygen to the sewage in the force main, and also into the wet well, in order to decrease odor and corrosion, while also saving costs by controlling the energy required to achieve the desired oxygen feed rate.

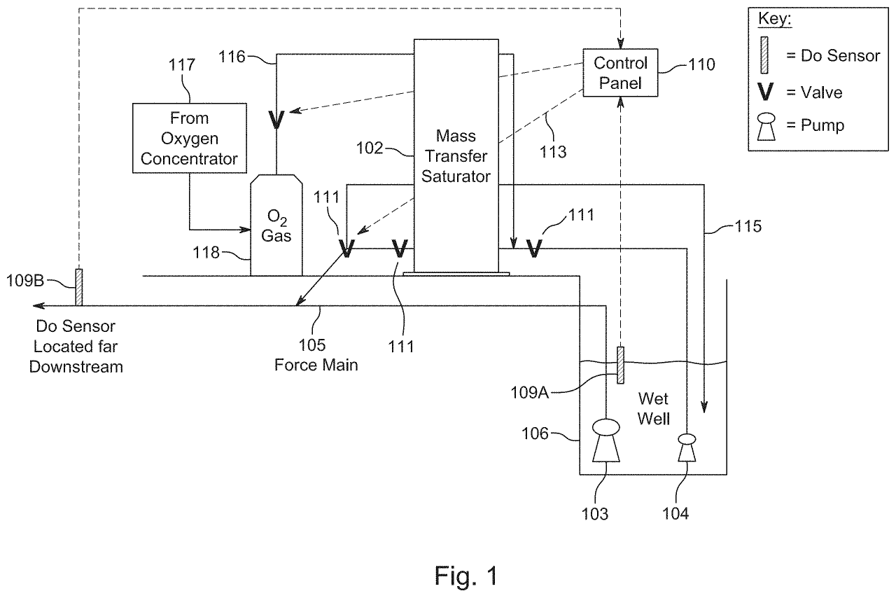

FIG. 1 illustrates one possible embodiment of a system according to the present invention. As depicted, and according to various embodiments of the present invention one or more pumps are located in the wet well 106. The wet well 106 serves as a holding tank for raw sewage. As depicted, a second smaller pump 104, or an additional outlet of the larger pump 103 within the wet well 106, can divert some sewage away from the force main 105 along a separate bypass line 115. For example, the pump(s) 103 or 104 can pump sewage toward a mass transfer saturator (“MTS”) 102. At the MTS 102, sewage is mixed with oxygen fed from line 116 through a valve 111, and given time to fully saturate. Said another way, the MTS 102 can act as a contact chamber to allow the O₂ to dissolve into solution. In some embodiments, the MTS 102 can be at above atmospheric pressure, and as a result additional dissolved oxygen may be forced into the sewage. Once properly mixed, the sewage can then be sent from the MTS 102, via a valve 111, to the force main 105, where the oxygenated sewage joins the regular sewage being pumped from the wet well 106. In other embodiments, the oxygen gas 118 may be sent directly to the force main 105. However, increased dissolution may be achieved using a contact chamber 102, for example, an MTS.

The addition of the sewage containing the elevated concentration of dissolved oxygen significantly raises the available oxygen within the force main. As depicted, a number of valves 111 may be used to control flow of oxygen gas 118 into the mass transfer saturator 102, as well as sewage into the MTS 102, out of the saturator 102, and into the force main 105, or back into the wet well 106. For example, if the oxygenated sewage is not needed, it may be returned to the wet well 106 or alternatively, the oxygen system blower may be turned off providing further energy savings.

In accordance with an embodiment of the present invention, oxygen is sourced from a compressor, which optionally serves an oxygen concentrator 117, which can purify the gas, before being stored in a tank 118. The system draws oxygen from the tank 118 as needed through operation of valves 111.

In accordance with the above example, and other examples, a control panel 110 may be used to control and operate any one of the valves via connections 113. Further, the control panel 110 may also have access to multiple sensors 109A-n, and use these sensor values to determine when to open or close one or more of the valves 111. The depicted DO sensors 109A and 109B, for example, measure dissolved oxygen content. These oxygen sensors may, for example, be placed in the wet well 106, and a second sensor 109B beyond the injection point for measuring the oxygenated sewage in the force main 105. Using these two sensors 109A-B, the controller 110 can determine the starting oxygen content at the wet well 106, as well as the post injection oxygen content and may increase or decrease the amount of additional oxygenated sewage being injected as necessary. For example, if low oxygen content is detected downstream from the injection point at sensor 109B, the controller 110 can turn on the lift pump 104 to move sewage toward and into the MTS 102 through line 115, and also open the valve 111 in oxygen line 116 at the outflow of the O₂ tank 118 in order to add oxygen into the MTS 102. Once the oxygen from the tank 118 has been given time to saturate into the sewage at the MTS 102, which may be determined according to a—or a combination of—pressure, oxygen, or time sensors, the controller 110 can operate a valve 111 at the MTS 102 to allow the oxygenated sewage to flow into the force main 105. Once the downstream sensor 109B achieves a recommended or target value, the valves 111 may be shut, and the MTS 102 contents can either remain in the MTS 102, or, alternatively, the controller 110 can allow the contents to return to the wet well 106.

The controller 110, as used in embodiments of the present invention, is preferably a computer operated system employing a software code to enable control over various components, such as valves, based on input values, such as sensor readings. The controller 110 preferably is able to constantly monitor sensor values, and carefully add or stop the flow of oxygenated sewage as appropriate. For example, the controller 110 is programmed with an agreed upon dissolved oxygen concentration at a specified location in the treated system. The controller 110 references the sensor values against this agreed upon dissolved oxygen concentration. If the sensor value exceeds the desired level threshold, the controller 110 can send a series of signals 113 in order to add oxygenated sewage into the force main 105, or to turn off the blower 117 in order to aid in energy savings. Or alternatively, where the wet well sensor 109A indicates a low dissolved oxygen level, the controller can send a series of signals to the appropriate valves 111, MTS 102, and O₂ tank 118 in order to recirculate oxygenated sewage back into the wet well 106.

The valves 111 as described can be any type of electronic, pneumatic, or other type of valve, preferably capable of automatic actuation upon reception of an appropriate signal 113.

The present invention may employ any number of injection points for the oxygenated sewage. For example, as depicted in FIG. 1, there may be a single injection point in the force main 105. However, in other embodiments, for example, there may be a first injection point, followed by a first sensor, and a second injection point, followed by a second sensor. In such an embodiment, the second injection point provides an additional opportunity to inject oxygenated sewage should the reading at the first sensor continue to show less than desired dissolved oxygen conditions. Further, an injection point may be made up of any number of actual injectors. For example, an injection point may be a 3 ft section of the force main, and may include four separate injectors, each of which send oxygenated sewage into the force main. More than one injector can allow for increased distribution of the oxygenated sewage, for example.

In accordance with other examples of the invention, the feed location where oxygen is being injected is selected from the group consisting of wet well, pump station, lift station, manhole, full pipe, siphon break section of pipe, headworks, force main, gravity line, lake, lagoon, basin, vault, sump, etc.

Embodiments of the present invention can employ a compressor in order to generate pressurized air. That pressurized air may be further refined into O₂ gas. The compressor and oxygen concentrator and O₂ gas chamber may all be controlled by the controller 110.

The present invention provides for additional financial benefits over the prior art by utilizing connectivity features. For example, using an internet connection, the controller can dynamically control the air compressor, which sends oxygen to the system, depending on electricity prices and load data. For example, when electricity is cheap, at night, the controller would signal the compressor to operate. The compressed air can then be stored for use by the system later.

The controller, according to various embodiments of the present invention, can also provide for remote access. This remote access (via a connection to the internet or intranet) can provide system supervisors with the ability to monitor the system from afar. Further, system supervisors may override the controller and manually control the aspects of the system as they see fit.

Many different types of sensors may be used according to the teachings of the present invention. For example, oxygen sensors may be used in the force main. However, in an alternative system, H₂S sensors may be used to detect high levels of H₂S which would then trigger the same type of oxygen injection response from the system. Various other sensors may also be included, for example, but not limited to, pressure sensors, flow rate sensors, temperature sensors, oxygen sensors, H₂S sensors, pH sensors, oxygen probe, gas-phase oxygen probe, soluble sulfide probe, or gas-phase sulfide probe, ORP Probe (oxidation reduction potential). The presently described system is designed to be easily configured and reconfigured should additional components be required or desired in order to optimize conditions.

Embodiments of the present invention also allow for pre-optimization of sewage conveyance system conditions in anticipation of a calendared event. For example, sewage line contents generally increase in the morning hours as households wake up. In anticipation of this influx of sewage, the conveyance system, the force main, for example, may be pre-loaded with additional oxygen in anticipation of the sudden increase in sewage volume. By pre-loading the force main with additional oxygen, anaerobic conditions are prevented. This type of pre-loading can be programmed into the system based on time, or other factors. For example, using the sensors of the present invention, the system may detect a pattern of low oxygen levels as sewage volume increases at a particular time. In anticipation of this, the system can pre-load the force main with additional oxygen.

While the preferred embodiment of the invention has been illustrated and described, as noted above, many changes can be made without departing from the spirit and scope of the invention. For example, the system may use different sensor types and arrangement of components to achieve the same goal of odor and pH control. Accordingly, the scope of the invention is not limited by the disclosure of the preferred embodiment. Instead, the invention should be determined entirely by reference to the claims that follow.

We claim:

1. A sewage treatment system comprising;
A sewage storage well;
A pipe in fluid communication with the sewage storage well and a pump, wherein the pump moves organic matter from the well and into the pipe;
An injection point at a point in the pipe downstream from the sewage storage well;
An oxygenated sewage source coupled to the injection point.

2. The sewage treatment system of claim 1 further comprising, a pump configured to move sewage through a second pipe and into the oxygenated sewage source, wherein the oxygenated sewage source is a mass transfer saturator.

3. The sewage treatment system of claim 1 further comprising a valve located between the oxygenated sewage source and the injection point, the valve in communication with a controller to actuate the valve, and wherein actuation of the valve allows oxygenated sewage to flow through the injection point into the pipe.

4. The sewage treatment system of claim 3 further comprising a sensor downstream from the injection point, the sensor in communication with the controller.

5. The sewage treatment system of claim 4 wherein the sensor is a dissolved oxygen sensor, and further wherein, the controller operates the valve located between the oxygenated sewage source and the injection point based on a sensor value from the dissolved oxygen sensor.

6. A wastewater treatment system comprising
A controller;
At least one pump located in a wet well, and in communication with the controller,
A first pipe, the first distal end of which is located in the wet well and in fluid communication with the at least one pump;
An oxygen contact chamber coupled to the wet well by a second pipe, the first distal end of the second pope located in the wet well and in fluid communication with the at least one pump;
At least one injection point in the first main pipe, the at least one injection point coupled to an outlet of the oxygen contact chamber, and further wherein at least one valve is located between the outlet of the oxygen contact chamber and the injection point, the valve in communication with the controller;
An oxygen source, the oxygen source in fluid communication with an inlet to the oxygen contact chamber, and wherein a valve in communication with the controller is located between the oxygen source and the inlet to the oxygen contact chamber;
At least one sensor coupled to the controller and located in the first pipe at a point downstream of the injection point.

7. A wastewater treatment system according to claim 6 further comprising wherein the at least one sensor is a dissolved oxygen sensor, and further wherein a value detected at the sensor is provided to the controller, and the controller, in response to the detected value, operates one or more valves.

8. The wastewater treatment system of claim 6 further comprising wherein the outlet of the oxygen contact chamber is in fluid communication with the wet well, and further wherein at least one valve is located between the outlet of the oxygen contact chamber and the wet well.

9. The wastewater treatment system of claim 6 wherein the oxygen contact chamber is above atmospheric pressure.

10. A method of controlling oxygen content in a sewage system comprising;
Pumping organic matter from a pump located in a wet well into a sewage system;
Diverting a portion of the organic matter from the wet well into an alternative pipe;
Transferring the portion of organic matter diverted into an alternative pipe into an oxygen contact chamber;
Introducing pressurized oxygen gas into the oxygen contact chamber, wherein the oxygen gas mixes with the organic matter to form oxygenated organic matter;
Injecting the oxygenated organic matter into a location selected from the group consisting of the sewage system at a point downstream from the wet well, and the wet well.
